(19) United States
(12) Patent Application Publication
(10) Pub. No.: US 2006/0245663 A1
(43) Pub. Date: Nov. 2, 2006

(54) Image-burr correcting system of camera

(75) Inventors: Kazuyoshi Yamagata, Fukushima-ken (JP); Masashi Tabata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/409,833

(22) Filed: Apr. 24, 2006

(30) Foreign Application Priority Data
Apr. 28, 2005 (JP) 2005-132742

(51) Int. Cl. G06K 9/40

(52) U.S. Cl. 382/262

(57) ABSTRACT

There is provided a high-performance image-burr correcting system of a camera, which can improve precision of a focusing process, accomplish low power consumption, and shorten a release time lag. The image-burr correcting system includes an image-burr detecting unit which can detect image burr generated upon photographing; an image-burr correcting unit which can correct the image burr based on the image-burr detection result of the image-burr detecting unit; and a focusing detecting unit which can detect the focused result. After the completion of an appropriate focusing process is detected by the focusing detecting unit, the image-burr correcting unit is driven and image-burr correction is performed in correspondence with an image burr amount detected by the image-burr detecting unit.

### BACKGROUND OF THE INVENTION

1. Field of the Invention

The present invention relates to an image-burr correcting system of a camera, and more particularly, to an image-burr correcting system of a camera, which corrects image burr generated by hand burr of the camera.

2. Description of the Related Art

Conventionally, various kinds of image-burr correcting systems of a camera, which correct image burr generated by hand burr of the camera, have been suggested.

Patent Documents 1 to 4 describe the various kinds of image-burr correcting systems presently available. In Patent Document 1 (Japanese Examined Patent Application Publication No. 07-117676), a focusing process and an image-burr correction process are initiated by a photographing preparation operation which presses a release button halfway.

In addition, in Patent Document 2 (Japanese patent No. 2752073), an image-burr correction process is initiated by a photographing preparation operation which presses a release button halfway. In Patent Document 2, the image-burr correction process is initiated by a predetermined operation different from a photographing initiation operation.

In addition, in Patent Document 3 (Japanese patent No. 3445334), an image-burr correction process is initiated according to an exposure initiation instruction and an exposure process is initiated after a predetermined time corresponding to an image burr amount lapses.

Moreover, in Patent Document 4 (Japanese patent No. 3590815), a focusing process and an image-burr detection process are performed in a predetermined time from a photographing preparation operation which performs a photographing preparation process, and an image-burr correction process is initiated after the predetermined time lapses.

By the conventional image-burr correcting systems, the image burr due to hand burr upon photographing is properly corrected.

[Patent Document 1] Japanese Examined Patent Application Publication No. 07-117676

[Patent Document 2] Japanese patent No. 2752073

[Patent Document 3] Japanese patent No. 3445334

[Patent document 4] Japanese patent No. 3590815

However, in the conventional image-burr correcting system of the camera disclosed in Patent Document 1, the image-burr correction process and the focusing process are simultaneously performed. To this end, since an actuator is driven in order to move a correction lens during the image-burr correction process, precision of the focusing process may deteriorate and a peak value of power consumption may increase.

In addition, in Patent Document 2, since the image-burr correction process is performed by the photographing preparation operation, when the focusing process is performed upon the image-burr correction process, precision of the focusing process may deteriorate, similar to Patent Document 1.

In Patent Document 2, since the image-burr correction process is performed by the predetermined operation different from the photographing initiation operation and the image-burr correction process is performed until the photographing preparation operation is initiated, power consumption increases.

In Patent Document 3, since the image-burr correction process is initiated by the exposure initiation instruction, although the exposure initiation instruction is given, an image-burr correction period becomes an exposure standby state and thus a release time lag from a time when the release button is pressed to a time when the exposure is actually initiated becomes longer.

Moreover, in Patent Document 4, when the predetermined time does not lapse from a time when the photographing preparation operation is initiated, the image-burr correction process is not initiated. To this end, although the focusing process is completed earlier than the predetermined time, the image-burr correction process must be in a standby state and thus the release time lag becomes longer.

### SUMMARY OF THE INVENTION

In order to solve the above-mentioned problems, an object of the present invention is to provide a high-performance image-burr correcting system of a camera, which can improve precision of a focusing process, accomplish low power consumption, and shorten a release time lag.

According to a first aspect of the present invention, there is provided an image-burr correcting system including an image-burr detecting unit which can detect image burr generated upon photographing; an image-burr correcting unit which can correct the image burr based on the image-burr detection result of the image-burr detecting unit; and a focusing detecting unit which can detect the focused result, wherein, immediately after the completion of an appropriate focusing process is detected by the focusing detecting unit, the image-burr correcting unit is driven and image-burr correction is performed in correspondence with an image burr amount detected by the image-burr detecting unit.

In addition, when the image-burr correcting unit initiates the image-burr correction and the image-burr correction using the image-burr correcting unit is completed according to a photographing initiation operation for initiating a photographing operation, exposure may be initiated.

According to the image-burr correcting system of the present invention, since the completion of the appropriate focusing process is detected by the focusing detecting unit and the image-burr correcting unit is then driven to correct image burr in correspondence with an image burr amount detected by the image-burr detecting unit, although minute vibration is generated in the camera by the drive of the actuator of the image-burr correcting unit upon controlling image-burr, the focusing process is already completed and thus it is possible to prevent precision of the focusing from deteriorating.

In addition, according to the present invention, since the image-burr correction is performed after the focusing process, it is possible to decrease power consumption upon peak.

Moreover, when the image-burr correcting unit initiates the image-burr correction and then the image-burr correction using the image-burr correcting unit is completed according to a photographing initiation operation for initiating a photographing operation, exposure is initiated. Accordingly, it is possible to shorten a release time lag and a photographing time.

### BRIEF DESCRIPTION OF THE DRAWINGS

FIG. 1 is a block diagram illustrating a schematic configuration of a camera according to the present invention; and

FIG. 2 is a flowchart illustrating an image-burr correcting method according to the present invention.

### DESCRIPTION OF THE PREFERRED EMBODIMENT

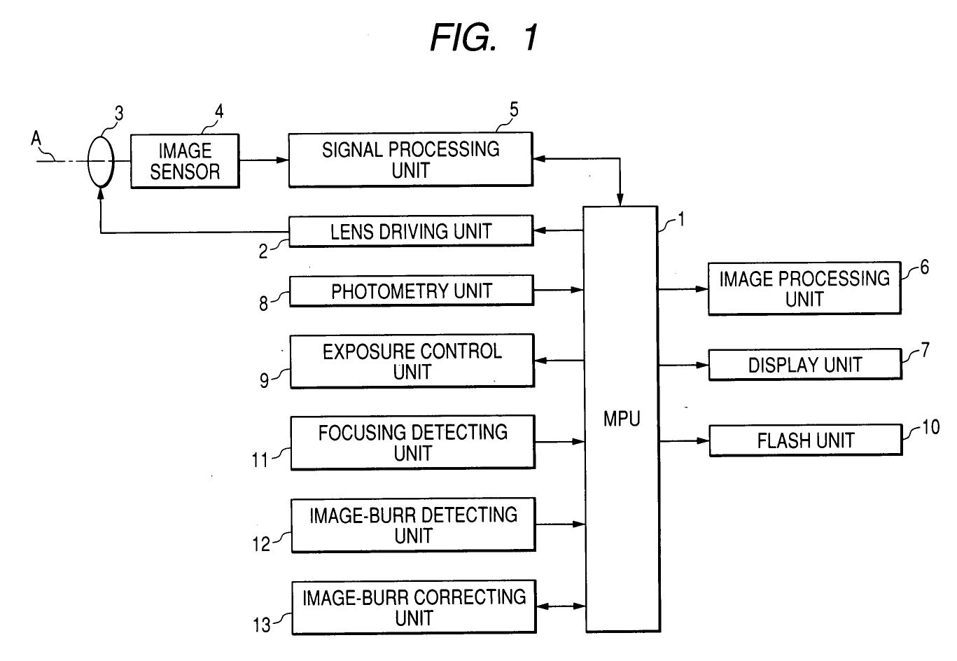

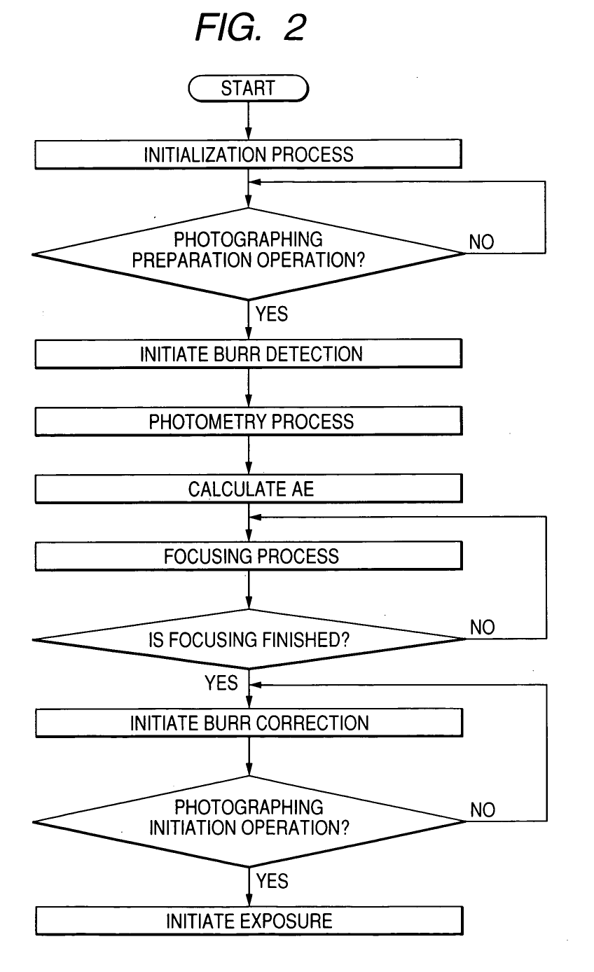

Hereinafter, an image-burr correcting system according to an embodiment of the present invention will be described with reference to FIGS. 1 and 2. FIG. 1 is a block diagram illustrating a schematic configuration of a camera according to the present invention, and FIG. 2 is a flowchart illustrating an image-burr correcting method according to the present invention.

First, in the configuration of a camera in which the image-burr correcting system according to the present invention is mounted, for example, a digital camera, as illustrated in FIG. 1, a microprocessing unit (MPU) 1 for controlling the camera is provided in the camera and an actuator of a lens driving unit 2 is driven by a signal supplied from the MPU 1 such that a lens 3 supported by a lens tube is moved in an optical axis A direction.

In addition, light entering into the camera through the lens 3 is accumulated in an image sensor (CCD) 4 as charges and an image signal is output from a signal processing unit 5 and input to the MPU 1. The image signal input to the MPU 1 is processed in an image processing unit 6 and, for example, it is determined whether the brightness of a subject is appropriate.

Moreover, the subject is projected onto a display unit 7 such that the focus or the brightness of the subject can be monitored.

Furthermore, a photometry unit 8 for measuring light intensity of the subject upon photographing is connected to the MPU 1 and a signal corresponding to the light intensity measured in the photometry unit 8 is output from the MPU 1 to an exposure control unit 9, which controls an aperture or a shutter speed to make exposure appropriate.

Although the exposure control unit 9 controls the exposure, when the photometric result of the photometry unit 8 is darkness which cannot be photographed by natural light, a flash unit 10 operates to shine the subject.

In addition, a focusing detecting unit 11 detects whether the projected image of the subject formed on an image sensor 4 is in a focused state and the detected result is fed back to a lens driving unit 2. When the projected image on the image sensor 4 is not in the focused state, the actuator of a lens driving unit 2 is driven to move the lens tube for supporting the lens 3 in the optical axis A direction and a focusing process is then performed.

Moreover, an image-burr detecting unit 12 detects whether an image is shaken with respect to the optical axis A direction due to hand burr of a photographer. When the image is shaken, the image is fed back to the image-burr correcting unit 13 to drive an actuator of the image-burr correcting unit 13 and to move a correction lens (not illustrated) in a plane perpendicular to the optical axis A, thereby correcting the image burr.

A method of correcting the image burr of the camera having the above-mentioned configuration will be described with reference to a flowchart illustrated in FIG. 2. First, when a power is applied, an initialization process of the MPU 1 is performed.

When a release button, which can be pressed in two steps, is pressed in a first step (halfway-press) by a release operation to perform a photographing preparation operation, burr detection is initiated by the image-burr detecting unit 12.

Thereafter, a photometry process is performed using the photometry unit 8 and appropriate light exposure is calculated by an AE calculation (exposure calculation). Although, in the flowchart of FIG. 2, the photometry process is performed after burr detection is initiated, the photometry process and the image-burr detection using the image-burr detecting unit 12 may be simultaneously performed.

In other words, the image-burr detection using the image-burr detecting unit is performed before or during the photometry process.

Next, after the photometry process, when the focusing detection is possible, a focusing process is performed.

In the focusing process, the lens 3 supported by the lens tube is moved in the optical axis A direction by driving the lens driving unit 2 to perform focusing of the projected image on the image sensor 4.

When the focusing process is completed, the image-burr detection result (image burr amount) of the image-burr detecting unit 12 is fed back to the image-burr correcting unit 13 and burr correction is initiated in correspondence with the image burr amount.

The burr correction is initiated and the image-burr correcting unit 13 follows the hand burr, photographing preparation completion is displayed on the display unit 7, and the release button is pressed in a second step. Thus, a photographing initiation operation is performed.

In addition, when the photographing initiation operation is performed before the image-burr correcting unit 13 follows the hand burr, the image-burr correcting unit 13 follows the hand burr and then exposure is automatically initiated, thereby performing the photographing.

In addition, when the brightness of the subject is improperly low, the flash unit is flashed and appropriate photographing is performed.

Moreover, although, in the embodiment of the present invention, the photographing initiation operation is performed after the burr correction is initiated, the photographing initiation operation may be performed after the focusing process is completed and before the burr correction may be performed.

In the image-burr correcting system of the camera according to the present invention, since the completion of the appropriate focusing process is detected by the focusing detecting unit 11 and the image-burr correcting unit 13 is then driven to correct the image burr in correspondence with the image burr amount detected by the image-burr detecting unit 12, although minute vibration is generated in the camera due to the drive of the actuator of the image-burr correcting unit 13 upon the image-burr correction, it is possible to prevent the precision of the focusing performed in the focusing process from deteriorating.

In addition, according to the present invention, since the photographing initiation operation for initiating the photographing operation is performed after the image-burr correcting unit 13 initiates the image-burr correction and the exposure is initiated after the image-burr correcting unit 13 follows the hand burr, a release time lag can be more shortened, compared with a conventional case where the image burr-correction is performed according to the exposure initiation instruction or a conventional case where the image-burr correction is performed after a predetermined time lapses from a time when the photographing preparation operation is initiated. Thus, it is possible to shorten a photographing time.

What is claimed is:

1. An image-burr correcting system comprising:
an image-burr detecting unit which can detect image burr generated upon photographing;
an image-burr correcting unit which can correct the image burr based on the image-burr detection result of the image-burr detecting unit; and
a focusing detecting unit which can detect the focused result,
wherein, immediately after the completion of an appropriate focusing process is detected by the focusing detecting unit, the image-burr correcting unit is driven and image-burr correction is performed in correspondence with an image burr amount detected by the image-burr detecting unit.

2. The image-burr correcting system according to claim 1, wherein, when the image-burr correcting unit initiates the image-burr correction and then the image-burr correction using the image-burr correcting unit is completed according to a photographing initiation operation for initiating a photographing operation, exposure is initiated.
